(19) United States
(12) Patent Application Publication
(10) Pub. No.: US 2002/0192329 A1
(43) Pub. Date: Dec. 19, 2002

(54) Confectionery product with pockets of trapped gas

(76) Inventors: Christine L. Corriveau, Orland Park, IL (US); Gregory J. Milosch, Oswego, IL (US)

Correspondence Address: Robert M. Barrett, Bell, Boyd & Lloyd LLC, P.O. Box 1135, Chicago, IL, 60690-1135, US

(21) Appl. No.: 10/163,334

(22) Filed: Jun. 4, 2002

Related U.S. Application Data
(60) Provisional application No. 60/295,995, filed on Jun. 5, 2001.

(51) Int. Cl. A23G 3/30

(52) U.S. Cl. 426/5

(57) ABSTRACT

A hard candy and confectionery product containing the hard candy that includes a sugar alcohol component, such as ISOMALT or a mixture of ISOMALT and one or more additional sugar alcholos, and a gas component trapped within a solid matrix of the hard candy is provided. In this regard, the hard candy and product(s) thereof are capable of effectively producing a popping or crackling sensation in one's mouth when the candy or product is chewed or dissolved orally.

### BACKGROUND OF THE INVENTION

The present invention generally relates to confectionery goods and methods of making same. More specifically, the present invention relates to confectionery goods that can produce a popping or crackling sensation when chewed or dissolved orally.

Hard candy that includes gas trapped within its solid structure is generally known and used. This type of candy is typically made by adding water to a mixture of sugar and corn syrup under a suitable cooking temperature. The ratio of sugar to corn syrup generally ranges from about 60:40 to about 40:60(on a dry solids basis). As the amount of corn syrup is increased, the hard candy becomes more hygroscopic, that is, its affinity to moisture from its surrounding environment increases.

In general, the gas is added to the mixture of sugar, corn syrup, water and other ingredients when this mixture has cooked down to a molten state. Upon cooling, the gas becomes trapped within the candy matrix as it hardens. The gas typically is carbon dioxide.

In use, this type of candy is typically used on its own, such as pop rock candy, crackling candy or other commercially available sources of this type of candy. As previously discussed, this type of candy has trapped gas within its solid matrix. When eaten, chewed or dissolved orally, this type of hard candy produces a popping, fizzling, crackling or other like sensation when the gas is released as the candy dissolves in the saliva of the mouth or the gas is released in some other way. The popping sensation creates an element of excitement and fun as the candy is eaten.

However, problems may arise during the use and/or manufacturing of this type of hard candy, particularly if the hard candy is combined with another material to form a confectionery good or product. As previously discussed, this type of hard candy is hygroscopic in nature when its overall surface area is increased by reducing it to a familiar particle size or small chunk. Its affinity to water from its surroundings becomes even greater as less sugar and more corn syrup are added to make the hard candy, such as a ratio of sugar to corn syrup from about 60:40 to about 40:60.

Because of its hygroscopic properties, its ability to produce a popping sensation within one's mouth may be reduced. In a moist environment, the hard candy may release some of its trapped gas before it is eaten. This problem is of particular concern when the hard candy is mixed with another component to form a confectionery product or good. The sheering force that results from mixing the hard candy with other confectionery components or materials can greatly enhance the hygroscopic properties of the hard candy by increasing its surface area even more as it is mixed. In this regard, its affinity to moisture from the surrounding environment increases. This can cause an even greater release of gas before the hard candy or product thereof is eaten. Thus, the popping sensation derived from the hard candy can be further reduced.

A need, therefore exists, to provide a hard candy that can be utilized on its own or as a component of a confectionery product to produce a popping sensation when chewed or dissolved orally resulting in enhanced levels of fun and excitement.

### SUMMARY OF THE INVENTION

The present invention provides a hard candy that includes a sugar alcohol component, such as ISOMALT or a mixture of ISOMALT and one or more additional sugar alcohols, and a gas component trapped within the solid matrix of the hard candy. In this regard, the hard candy is capable of producing a popping or crackling sensation when the hard candy is chewed or dissolved orally on its own or within a confectionery good or product. Due to the sugar alcohol component, the hard candy of the present invention is less hygroscopic than commonly used hard candies of this type. This significantly enhances the “popping” or “crackling” features of the hard candy when chewed or orally dissolved, including a confectionery product composed of the hard candy.

To this end, in an embodiment of the present invention, a candy in a solid form is provided. The candy includes a sugar alcohol component and a gas component. In an embodiment, the sugar alcohol component comprises one or more sugar alcohols.

In an embodiment, the sugar alcohol component comprises at least ISOMALT.

In another embodiment, a confectionery product capable of producing a popping sensation when chewed or dissolved orally is provided. The confectionery product includes a confectionery base material and a solid bard candy component added to the confectionery base material wherein the solid hard candy component includes one or more sugar alcohols and a gas trapped within the solid hard candy.

In yet another embodiment, a method of making a hard candy is provided. The method includes the steps of mixing one or more sugar alcohols in an amount of water; cooking to a moisture level ranging from about 0.5% to about 2.0% by weight of the hard candy; adding a gas consisting essentially of carbon dioxide to the mixture of the sugar alcohol and the water; and forming a plurality of pockets of the gas within the hard candy.

In still yet another embodiment, a method of making a confectionery product capable of producing a crackling sensation when contacting saliva is provided. The method includes the steps of providing a confectionery base material; and adding a solid hard candy to the confectionery base material wherein the solid hard candy includes a sugar alcohol component and a plurality of pockets of a gas consisting essentially of carbon dioxide.

It is, therefore, an advantage of the present invention to provide a hard candy that includes a sugar alcohol component and a gas trapped within a solid matrix of the hard candy.

Another advantage of the present invention is to provide a confectionery product that includes a solid hard candy element which has a sugar alcohol component and a gas component trapped within the solid hard candy element.

A further advantage of the present invention is to provide a hard candy that can be utilized on its own or as part of a confectionery product to produce a popping sensation when chewed or dissolved orally.

A still further advantage of the present invention is to provide enhanced levels of fun and excitement when the hard candy or confectionery product containing the hard candy is chewed or dissolved orally.

Additional features and advantages of the present invention are described in, and will be apparent in, the detailed description of the presently preferred embodiments.

### DETAILED DESCRIPTION OF THE PRESENTLY PREFERRED EMBODIMENTS

The present invention provides a hard candy and confectionery products thereof that include a sugar alcohol component and a gas component trapped within a solid matrix of the hard candy. In this regard, the hard candy has the ability to produce a popping, crackling or other like sensation when the candy is chewed or dissolved orally within one's mouth. This sensation provides an enhanced level of excitement and fun during use.

In an embodiment, the present invention provides a hard candy having a solid form that contains a sugar alcohol component and a gas component trapped within the solid form. The sugar alcohol component is a substitute for typically used sugar and corn syrup ingredients. This results in a hard candy that can have reduced levels of hygroscopic properties as compared to commonly used and commercially available hard candy products of this type.

In this regard, the reduced hygroscopic nature of the hard candy of the present invention results in an abundance of trapped gas that is not released before it is eaten as compared to commercially available hard candy and products thereof. Thus, the popping and/or crackling sensation that one feels upon chewing or orally dissolving the hard candy of the present invention can be significantly enhanced.

The sugar alcohol component can be made of a variety of different materials and amounts thereof. In general, the sugar alcohol component can be derived from any suitable sugar component or saccharide. For example, the sugar alcohol or mixture or blend of sugar alcohols can be made from the hydrogenation of sugar, other like processes or combinations thereof. In an embodiment, ISOMALT, which is a commercially available product, is preferred. In an embodiment, ISOMALT may be combined, mixed or blended with one or more additional sugar alcohols, such as, sorbitol, mannitol, xylitol, hydrogenated starch hydrolysates, maltitol, lactitol, syrups, like sugar alcohols or combinations thereof It should be appreciated that sugar alcohols other than ISOMALT may not be effective or at least not as effective as ISOMALT to enhance the popping and/or crackling sensation of the hard candy of the present invention.

The popping or crackling sensation produced from the hard candy of the present invention results from the release of the gas component from the hard candy as it is chewed or dissolved orally. For example, the saliva of one's mouth can dissolve the hard candy, thus releasing the gas as the candy surface encapsulating the gas is dissolved. The gas component can include any suitable amount of gas. The gas preferably contains a gas that is less dense than air, and most preferably is carbon dioxide.

Carbon dioxide is a relatively inert gas, and therefore can be safely used within a food grade product, such as the hard candy of the present invention. Carbon dioxide is much less dense than air. In this regard, the carbon dioxide vigorously escapes into the atmosphere once it is released from the pockets within the hard candy, thus creating a popping or crackling sensation in one's mouth when the hard candy is chewed or orally dissolved.

In an embodiment, the present invention provides a confectionery product capable of producing a popping or crackling sensation when chewed or dissolved orally. The confectionery product includes the hard or solid hard candy as previously discussed. The solid hard candy component is added to a confectionery base material. The combination of the solid hard candy and confectionery base material enables the confectionery good to produce similar popping and crackling sensations when chewed or dissolved orally as compared to that of the hard candy on its own.

The confectionery product is not limited to any particular type of product. The only limitation is that the base material can be suitably mixed with the solid hard candy component. For example, the confectionery base material can include any suitable gum, such as bubble gum, chewing gum or other like gum. The solid hard candy component can be added to the gum under any suitable and typical mixing and other operating conditions.

As previously discussed, the hard candy of the present invention can better withstand moisture from its surrounding environment. In this regard, the end product, namely the confectionery product, has an enhanced ability to produce popping and crackling as compared to a confectionery product which includes typically known and used solid hard candy components, such as pop rocks and crackling candy.

In an embodiment, the present invention provides methods of making the hard candy and confectionery product thereof. Any suitable condition, step, operation or other like operating parameters can be utilized to effectively produce a hard candy and/or confectionery product that is capable of producing a popping or crackling sensation when chewed or dissolved orally. The essential steps of making the hard candy include mixing a sugar alcohol or a mixture or blend of sugar alcohols, preferably at least including ISOMALT as previously discussed, in an amount of water. However, other ingredients typically utilized in making hard candy, such as flavor, acid, base or the like can also be added during preparation.

The mixture is typically cooked to produce a molten phase into which the gas, such as carbon dioxide, is added. For example, the hard candy is cooked to a moisture level ranging from about 0.5% to about 2.0% by weight of the hard candy, preferably about 0.75% to about 1.5% by weight of the hard candy. The mixture containing the gas is then cooled such that pockets of the gas are contained within the resulting hard candy.

The confectionery product can be made by utilizing any suitably known operation or technique. The essential steps of making the confectionery product include providing some type of base material and adding to that material the hard candy which has sugar alcohol component and a plurality of pockets of gas, such as carbon dioxide. As applied to making a gun, the hard candy component is added during the mixing stage that is typically conducted with a sigma blade.

It should be appreciated that the methods of making hard candy and confectionery products thereof of the present invention can include any variety, number and amount of process steps, process procedures, operating conditions or other like features such that the end result is a hard candy or confectionery product thereof that can produce enhanced popping sensations when chewed or dissolved orally.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that all such changes and modifications be covered by the appended claims.

We claim:

1. A candy in a solid form comprising a sugar alcohol component and a gas component.

2. The candy of claim 1 wherein the sugar alcohol component is derived from a sugar component.

3. The candy of claim 1 wherein the sugar alcohol component comprises one or more sugar alcohols.

4. The candy of claim 3 wherein the sugar alcohol component comprises at least ISOMALT.

5. The candy of claim 1 wherein the gas component contains a gas that is less dense than a gas composed of air.

6. The candy of claim 5 wherein the gas consists essentially of carbon dioxide.

7. The candy of claim 1 wherein the gas component is trapped inside a plurality of pockets within the solid form of the candy.

8. The candy of claim I wherein the candy produces a popping sensation when chewed or dissolved orally.

9. A confectionery product capable of producing a popping sensation when chewed or orally dissolved comprising a confectionery base material and a solid hard candy component added to the confectionery base material, the solid hard candy component including one or more sugar alcohols and a gas trapped within the solid hard candy.

10. The confectionery product of claim 9 wherein the sugar alcohol is derived from a saccharide.

11. The confectionery product of claim 9 wherein the sugar alcohol comprises at least ISOMALT.

12. The confectionery product of claim 9 wherein the gas consists essentially of carbon dioxide.

13. The confectionery product of claim 9 wherein the confectionery base material is a gum.

14. A method of making a hard candy comprising the steps of:
mixing one or more sugar alcohols and an amount of water;
cooking to a moisture level ranging from about 0.5% to about 2.0% by weight of the hard candy;
adding a gas consisting essentially of carbon dioxide to the mixture of sugar alcohol and water; and
forming a plurality of pockets of the gas within the hard candy.

15. The method of claim 14 wherein the sugar alcohol is derived from a sugar component.

16. The method of claim 14 wherein the sugar alcohol comprises at least ISOMALT.

17. A method of making a confectionery product capable of producing a crackling sensation when contacting saliva comprising the steps of:
providing a confectionery base material; and
adding a solid hard candy to the confectionery base material wherein the solid hard candy includes a sugar alcohol component and a plurality of pockets of a gas consisting essentially of carbon dioxide.

18. The method of claim 17 wherein the sugar alcohol component comprises one or more sugar alcohols.

19. The method of claim 18 wherein the sugar alcohol comprises at least ISOMALT.

20. The method of claim 17 wherein the confectionery base material is a gum.
